(19) United States
(12) Patent Application Publication
(10) Pub. No.: US 2026/0031013 A1
(43) Pub. Date: Jan. 29, 2026

(54) DISPLAY DEVICE, ELECTRONIC DEVICE INCLUDING THE SAME, AND METHOD OF DRIVING THE SAME

(71) Applicant: Samsung Display Co., Ltd., Yongin-si (KR)

(72) Inventors: Seok Ha HONG, Yongin-si (KR); Ju Seo KIM, Yongin-si (KR); Kang Hee LEE, Yongin-si (KR); Jin Hwan CHO, Yongin-si (KR); Mi Young JOO, Yongin-si (KR)

(21) Appl. No.: 19/238,859

(22) Filed: Jun. 16, 2025

(30) Foreign Application Priority Data
Jul. 29, 2024 (KR) 10-2024-0100224

(51) Int. Cl. G09G 3/20; G09G 3/3233

(52) U.S. Cl. CPC G09G 3/2007; G09G 3/3233; G09G 2300/0842; G09G 2320/045; G09G 2320/048

(57) ABSTRACT

A display device includes: a pixel including a light emitting element; and a degradation compensator to determine a compensation value for an input grayscale value of the pixel, based on the input grayscale value and at least one of a cumulative usage time or a cumulative degradation value of the light emitting element. The degradation compensator is to determine a compensation gain, based on a dynamic range of a driving transistor of the pixel and at least one of the cumulative usage time or the cumulative degradation value. The degradation compensator is to determine an output grayscale value of the pixel, based on the compensation value and the compensation gain.

### CROSS-REFERENCE TO RELATED APPLICATION

The present application claims priority to and the benefit of Korean Patent Application Number 10-2024-0100224, filed on Jul. 29, 2024, in the Korean Intellectual Property Office, the entire disclosure of which is incorporated by reference herein.

### BACKGROUND

### 1. Field

Aspects of embodiments of the present disclosure relate to a display device, an electronic device including the display device, and a method of driving the display device.

### 2. Description of Related Art

With the development of information technology, the importance of display devices, which sever as a connection medium between users and information, has been emphasized. As such, the use of various kinds of display devices, such as a liquid crystal display device and an organic light emitting display device, has increased. Each pixel of a display device may include at least one light emitting

element. The light emitting element may degrade as a period of use increases, and thus, more driving current may be required to maintain the same luminance.

The above information disclosed in this Background section is for enhancement of understanding of the background of the present disclosure, and therefore, it may contain information that does not constitute prior art.

### SUMMARY

Embodiments of the present disclosure may be directed to a display device capable of more accurately compensating for a degradation by reflecting a process variation or deviation of each display panel, an electronic device including the display device, and a method of driving the display device.

According to one or more embodiments of the present disclosure, a display device includes: a pixel including a light emitting element; and a degradation compensator configured to determine a compensation value for an input grayscale value of the pixel, based on the input grayscale value and at least one of a cumulative usage time or a cumulative degradation value of the light emitting element. The degradation compensator is configured to determine a compensation gain, based on a dynamic range of a driving transistor of the pixel and at least one of the cumulative usage time or the cumulative degradation value. The degradation compensator is configured to determine an output grayscale value of the pixel, based on the compensation value and the compensation gain.

In an embodiment, the dynamic range may correspond to a difference between a gate-source voltage of the driving transistor to flow a driving current corresponding to a minimum grayscale value and a gate-source voltage of the driving transistor to flow a driving current corresponding to a maximum grayscale value.

In an embodiment, the degradation compensator may be configured to determine the compensation gain based on at least one of the cumulative usage time or the cumulative degradation value, the dynamic range, and at least one of an emission efficiency or an emission surface area of the light emitting element.

In an embodiment, the degradation compensator may be configured to determine the compensation gain to be smaller as the dynamic range increases.

In an embodiment, the degradation compensator may be configured to determine the compensation gain to be smaller as the emission efficiency increases.

In an embodiment, the degradation compensator may be configured to determine the compensation gain to be smaller as the emission surface area increases.

In an embodiment, the degradation compensator may be configured to determine a first weight applied to the dynamic range to be a smaller value as the cumulative usage time and the cumulative degradation value increase.

In an embodiment, the degradation compensator may be configured to determine a second weight applied to at least one of the emission efficiency or the emission surface area to be a larger value as the cumulative usage time and the cumulative degradation value increase.

In an embodiment, the degradation compensator may be configured to determine the compensation gain according to CPG=DRd[n]*w1[n]+ELd[n]*w2[n], where CPG may denote the compensation gain, DRd[n] may denote a first gain corresponding to the dynamic range, w1[n] may denote the first weight, ELd[n] may denote a second gain corresponding to the emission efficiency and the emission surface area, and w2[n] may denote the second weight.

In an embodiment, the degradation compensator may be configured to determine the output grayscale value according to OGV=IGV+CPV*CPG, where OGV may denote the output grayscale value, IGV may denote the input grayscale value, CPV may denote the compensation value, and CPG may denote the compensation gain.

According to one or more embodiments of the present disclosure, a method of driving a display device comprises: receiving an input grayscale value of a pixel including a light emitting element; determining a compensation value for the input grayscale value, based on the input grayscale value and at least one of a cumulative usage time or a cumulative degradation value of the light emitting element; determining a compensation gain, based on a dynamic range of a driving transistor of the pixel and at least one of the cumulative usage time or the cumulative degradation value; and determining an output grayscale value of the pixel based on the compensation value and the compensation gain.

In an embodiment, the dynamic range may correspond to a difference between a gate-source voltage of the driving transistor to flow a driving current corresponding to a minimum grayscale value and a gate-source voltage of the driving transistor to flow a driving current corresponding to a maximum grayscale value.

In an embodiment, the determining of the compensation gain may include determining the compensation gain, based on at least one of the cumulative usage time or the cumulative degradation value, the dynamic range, and at least one of an emission efficiency or an emission surface area of the light emitting element.

In an embodiment, the determining of the compensation gain may include determining the compensation gain to be smaller as the dynamic range increases.

In an embodiment, the determining of the compensation gain may include determining the compensation gain to be smaller as the emission efficiency increases.

In an embodiment, the determining of the compensation gain may include determining the compensation gain to be smaller as the emission surface area increases.

In an embodiment, the determining of the compensation gain may include determining a first weight applied to the dynamic range to be a smaller value as the cumulative usage time and the cumulative degradation value increase.

In an embodiment, the determining of the compensation gain may include

determining a second weight applied to at least one of the emission efficiency or the emission surface area to be a larger value as the cumulative usage time and the cumulative degradation value increase.

In an embodiment, the compensation gain may be determined according to CPG=DRd[n]*w1[n]+ELd[n]*w2[n], where CPG may denote the compensation gain, DRd[n] may denote a first gain corresponding to the dynamic range, w1[n] may denote the first weight, ELd[n] may denote a second gain corresponding to the emission efficiency and the emission surface area, and w2[n] may denote the second weight.

In an embodiment, the output grayscale value may be determined according to OGV=IGV+CPV*CPG, where OGV may denote the output grayscale value, IGV may denote the input grayscale value, CPV may denote the compensation value, and CPG may denote the compensation gain.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram illustrating a display device in accordance with an embodiment of the present disclosure.

FIG. 2 is a diagram illustrating blocks in accordance with an embodiment of the present disclosure.

FIG. 3 is a diagram illustrating a pixel in accordance with an embodiment of the present disclosure.

FIG. 4 is a diagram illustrating a degradation compensator in accordance with an embodiment of the present disclosure.

FIG. 5 is a diagram illustrating a mutual relationship between a dynamic range and a luminance change rate.

FIG. 6 is a diagram illustrating a first gain in accordance with an embodiment of the present disclosure.

FIG. 7 is a diagram illustrating a second gain in accordance with an embodiment of the present disclosure.

FIG. 8 is a diagram illustrating a first weight and a second weight in accordance with an embodiment of the present disclosure.

FIG. 9 is a diagram illustrating a display device in accordance with an embodiment of the present disclosure.

FIG. 10 is a diagram illustrating a degradation compensator in accordance with an embodiment of the present disclosure.

FIG. 11 is a block diagram of an electronic device in accordance with an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

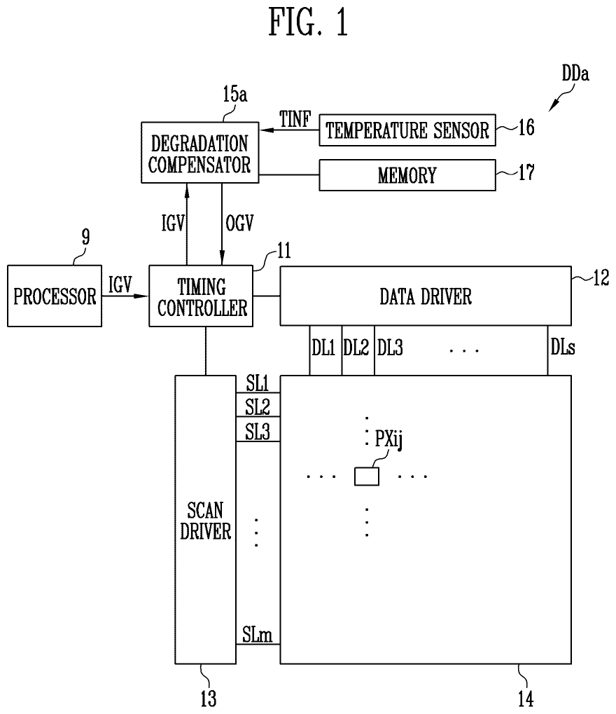

FIG. 1 is a diagram illustrating a display device DDa in accordance with an embodiment of the present disclosure.

Referring to FIG. 1, the display device DDa in accordance with an embodiment of the present disclosure may include a timing controller 11, a data driver 12, a scan driver 13, a pixel component 14, a degradation compensator 15a, a temperature sensor 16, and a memory 17. A processor 9 (e.g., a graphics processing unit (GPU), a central processing unit (CPU), or an application processor (AP)) is configured to provide an image signal. The display device DDa is configured to display an image based on the image signal.

The timing controller 11 may receive input grayscale values IGV and timing signals, such as a vertical synchronization signal, a horizontal synchronization signal, a data enable signal, and the like, from the processor 9 for each image frame.

The timing controller 11 may supply control signals to the data driver 12 and the scan driver 13 corresponding to specifications of each thereof. Furthermore, the timing controller 11 may provide the input grayscale values IGV to the degradation compensator 15a, and may receive output grayscale values OGV from the degradation compensator 15a. The timing controller 11 may provide the output grayscale values OGV to the data driver 12.

The timing controller 11 and the degradation compensator 15a may be configured as independent hardware from each other, or may be configured together as a single integrated hardware (e.g., an integrated circuit (IC)). The degradation compensator 15a may also be implemented in software in the timing controller 11.

In another embodiment, unlike that illustrated in FIG. 1, the timing controller 11 may provide the input grayscale values IGV to the data driver 12. In this case, the degradation compensator 15a may receive the input grayscale values IGV from the data driver 12, and may also provide the output grayscale values OGV to the data driver 12. Hereinafter, for convenience of illustration, the configuration shown in the embodiment illustrated in FIG. 1 will be described in more detail. In an embodiment, the timing controller 11 and the data driver 12 may be configured together as a single integrated hardware (e.g., an integrated circuit (IC)).

The data driver 12 may generate, using the output grayscale values OGV and control signals, data voltages to be provided to data lines DL1 to DLs. Here, s is an integer greater than 0. For example, the data driver 12 may sample the output grayscale values OGV using a clock signal, and may apply the data voltages corresponding to the output grayscale values OGV to the data lines DL1 to DLs on a pixel row basis. The pixel row may refer to pixels that are connected to the same scan line as each other.

The scan driver 13 may receive a clock signal, a scan start signal, and the like from the timing controller 11, and may generate scan signals to be provided to the scan lines SL1 to SLm. Here, m is an integer greater than 0.

The scan driver 13 may sequentially supply the scan signals, each having a turn-on level pulse, to the scan lines SL1 to SLm. The scan driver 13 may include scan stages configured in the form of a shift register. The scan driver 13 may generate the scan signals by sequentially transmitting a scan start signal having a turn-on level pulse to a subsequent scan stage under the control of a clock signal.

The pixel component 14 includes pixels with light emitting elements. Each pixel may be connected to a corresponding data line and a corresponding scan line. A pixel PXij from among the pixels may refer to a pixel including a scan transistor that is connected to an i-th scan line and a j-th data line. Here, i and j may each be an integer greater than 0.

In some embodiments, the display device DDa may further include an emission driver. The emission driver may receive a clock signal, an emission stop signal, and the like from the timing controller 11, and may generate emission signals to be provided to emission lines. For example, the emission driver may include emission stages connected to the emission lines. The emission stages may be configured in the form of a shift register. For example, a first emission stage may generate a turn-off level emission signal based on a turn-off level emission stop signal. The other emission stages may sequentially generate turn-off level emission signals based on turn-off level emission signals of corresponding previous emission stages, respectively.

If (e.g., when) the display device DDa includes the emission driver, each pixel PXij may further include a transistor connected to the corresponding emission line. The transistor may be turned off during a data write period of the corresponding pixel PXij, thus preventing the corresponding pixel PXij from emitting light. However, the present disclosure is not limited thereto, and for convenience of illustration, one or more embodiments in which the emission driver is not provided may be described in more detail hereinafter.

The temperature sensor 16 may provide temperature information TINF. The temperature information TINF may include an ambient temperature of the display device DDa. For example, a single temperature sensor 16 (e.g., only one temperature sensor) may be provided in the display device DDa.

The degradation compensator 15a may calculate estimated temperatures of individual pixels or blocks based on the input grayscale values IGV and the temperature information TINF. For example, based on the ambient temperature, the pixels with higher input grayscale values may be calculated to have higher estimated temperatures. In another embodiment, the degradation compensator 15a may use a current sensor provided in the display device DDa to calculate the estimated temperatures more accurately. For example, based on the ambient temperature, the pixels with higher input grayscale values and greater flowing currents may be calculated to have higher estimated temperatures. The calculation of the estimated temperatures may be performed by any suitable technique as would be understood by those having ordinary skill in the art. In another example, the temperature sensor 16 may include a plurality of temperature sensors provided in units of pixels or blocks.

The memory 17 may store cumulative degradation values in units of pixels or blocks. The memory 17 may be a dedicated memory, or may be a part of another memory (e.g., a frame memory). The memory 17 may be implemented using any suitable data storage device (e.g., a static RAM (SRAM), a dynamic RAM (DRAM), a pseudo SRAM (PSRAM), a synchronous DRAM (SDRAM), a double data rate SDRAM (DDR SDRAM), or the like).

The cumulative degradation values may refer to degradation information for the respective pixels or the respective blocks from an initial operation time point of the display device DDa to a most recent update time point. As a cumulative degradation value increases, the driving current used for the corresponding pixel or the corresponding block to achieve the same luminance may be increased. For example, the cumulative degradation value of the corresponding pixel or block may increase with higher grayscale values, higher operating temperatures, and longer usage time periods. On the other hand, the cumulative degradation value of the corresponding pixel or block may decrease with lower grayscale values, lower operating temperatures, and shorter usage time periods.

The degradation compensator 15a may calculate a current degradation value of each pixel or block based on the temperature information TINF (or the estimated temperatures) and the input grayscale values IGV. The degradation compensator 15a may receive an existing cumulative degradation value of each pixel or block from the memory 17, and may generate a new cumulative degradation value of the pixel or block by accumulating the current degradation value to the existing cumulative degradation value. The degradation compensator 15a may update the memory 17 with the new cumulative degradation value. To reduce memory costs, the memory 17 may not retain the existing cumulative degradation values preceding the new cumulative degradation value.

The degradation compensator 15a may generate output grayscale values OGV for the pixels PXij based on the input grayscale values IGV and the cumulative degradation values of the pixels PXij

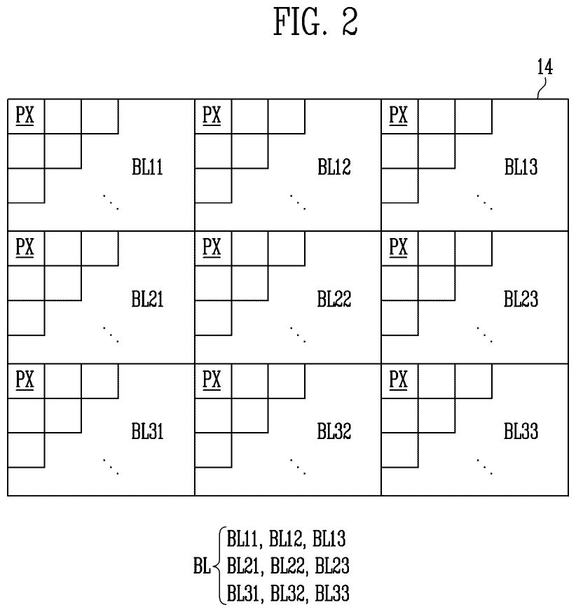

FIG. 2 is a diagram illustrating blocks in accordance with an embodiment of the present disclosure.

As illustrated in FIG. 2, pixels PX included in the pixel component 14 may be divided into a plurality of blocks BL11, BL12, BL13, BL21, BL22, BL23, BL31, BL32, and BL33. For example, each of the blocks BL11 to BL33 may include the same number of pixels PX as each other, and the blocks BL11 to BL33 may not overlap with each other. In another embodiment, the blocks BL11 to BL33 may include different numbers of pixels PX from one another. In another embodiment, the blocks BL11 to BL33 may share at least some of the pixels PX with each other (e.g., may overlap with each other).

Each block BL may be a virtual element to define a unit of controlling a plurality of pixels PX, and may not be a physical component. The blocks BL may be written to and defined in the memory (e.g., the memory 17) before product shipment, and may also be actively redefined during a process of using the product.

For convenience of illustration, FIG. 2 shows that the blocks BL11 to BL33 are divided into three rows and three columns, but the number of blocks BL is not limited thereto, and may be variously modified as needed or desired in response to the specifications (e.g., a size, a resolution, and the like) of the pixel component 14.

For example, when the number of pixels of the pixel component 14 is 3840*2160, the estimated temperatures may be calculated for units of relatively larger blocks (e.g., each block including pixels of 240*120), while degradation levels may be stored for units of relatively smaller blocks (e.g., each block including pixels of 8*8).

Data for relatively larger block units and data for relatively smaller block units may be aligned by matching the unit size (e.g., the number of pixels included in each block) for calculation purposes therebetween. For example, by interpolating adjacent relatively larger block units (e.g., a bilinear interpolation), the larger block units may be calculated in relatively smaller block units or individual pixel units. On the other hand, by averaging values of adjacent relatively smaller block units or individual pixel units, the smaller block units or individual pixel units may be calculated in relatively larger block units. As such, depending on the use or purpose (e.g., taking into account memory costs, accuracy, and the like), individual pixel units, relatively smaller block units, and relatively larger block units may be used in different manners, and may be compatible with each other.

Hereinafter, for convenience of illustration, calculations will be described as being performed in individual pixel units, but the present disclosure is not limited thereto, and block-based calculations can also be performed in parallel with interpolation and average value calculations.

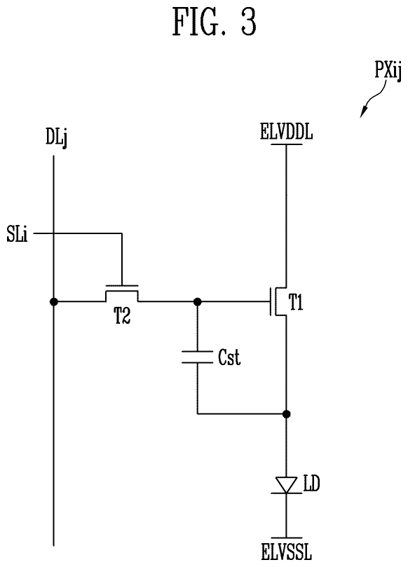

FIG. 3 is a diagram illustrating a pixel PXij in accordance with an embodiment of the present disclosure.

Referring to FIG. 3, the pixel PXij may include transistors T1 and T2, a storage capacitor Cst, and a light emitting element LD.

A circuit configured of N-type transistors will be described in more detail hereinafter as a representative example. However, a circuit configured of P-type transistors may be used as would be understood by those having ordinary skill in the art by changing the polarity of the voltage to be applied to a gate terminal of each of the transistors. Similarly, a circuit configured of a combination of a P-type transistor and an N-type transistor may be used as would be understood by those having ordinary skill in the art. As used herein, the term “P-type transistor” is a general name for transistors in which the amount of current increases when a voltage difference between a gate electrode and a source electrode increases in a negative direction. As used herein, the term “N-type transistor” is a general name for transistors in which the amount of current increases when a voltage difference between a gate electrode and a source electrode increases in a positive direction. Each transistor may be configured in various suitable forms, such as a thin film transistor (TFT), a field effect transistor (FET), and/or a bipolar junction transistor (BJT).

The first transistor T1 may include a gate electrode connected to a first electrode of the storage capacitor Cst, a first electrode connected to a first power line ELVDDL, and a second electrode connected to a second electrode of the storage capacitor Cst. The first transistor T1 may be referred to as a “driving transistor”.

The second transistor T2 may include a gate electrode connected to an i-th scan line SLi, a first electrode connected to a j-th data line DLj, and a second electrode connected to the gate electrode of the first transistor T1. The second transistor T2 may be referred to as a “scan transistor”. Here, i and j may each be an integer greater than 0.

The first electrode of the storage capacitor Cst may be connected to the gate electrode of the first transistor T1. The second electrode of the storage capacitor Cst may be connected to the second electrode of the first transistor T1.

The light emitting element LD may include an anode connected to the second electrode of the first transistor T1, and a cathode connected to a second power line ELVSSL. The light emitting element LD may be formed of an organic light emitting diode, an inorganic light emitting diode, a quantum dot/well light emitting diode, or the like. Although an example in which the pixel PXij includes one light emitting element LD is illustrated in FIG. 3, the pixel PXij may include a plurality of light emitting elements connected in series, parallel, or series-parallel to each other in other embodiments.

A first power voltage may be applied to the first power line ELVDDL. A second power voltage may be applied to the second power line ELVSSL. For example, the first power voltage may be greater than the second power voltage during an image display period.

If (e.g., when) a turn-on level (e.g., a logic high level) scan signal is applied through the scan line SLi, the second transistor T2 is turned on. In this case, a data voltage applied to the data line DLj may be stored in the first electrode of the storage capacitor Cst.

A driving current corresponding to a difference in voltage between the first electrode and the second electrode of the storage capacitor Cst may flow between the first electrode and the second electrode of the first transistor T1. Therefore, the light emitting element LD may emit light having a luminance corresponding to the data voltage.

If (e.g., when) a turn-off level (e.g., a logic low level) scan signal is applied through the scan line SLi, the second transistor T2 may be turned off, and the data line DLj and the first electrode of the storage capacitor Cst may be electrically separated from each other. Thus, even if the data voltage of the data line DLj changes, the voltage stored in the first electrode of the storage capacitor Cst may not change.

However, the present disclosure is not limited to the pixel PXij described above with reference to FIG. 3, and pixels of other suitable pixel circuits may be included. For example, in the case where the display device DDa further includes the emission driver, the pixel PXij may further include a transistor connected to the corresponding emission line.

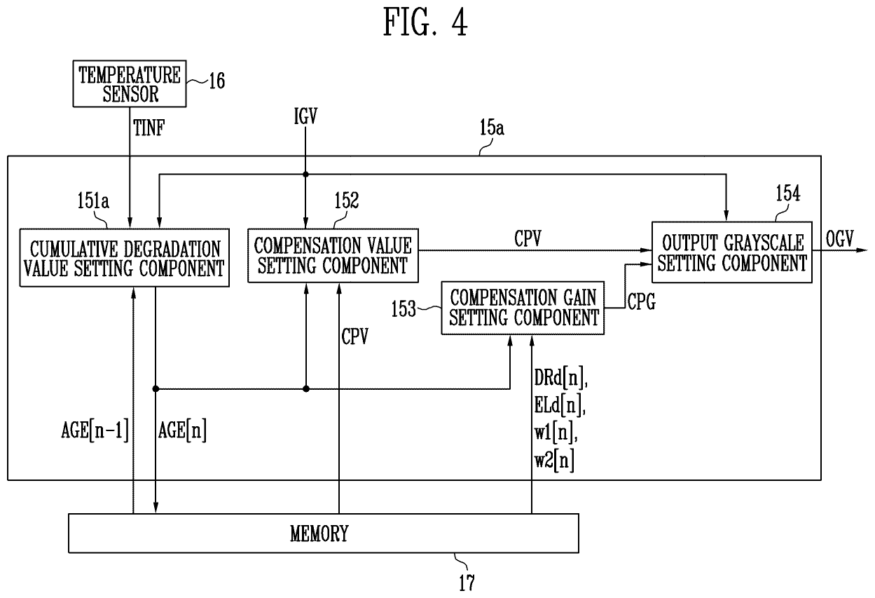

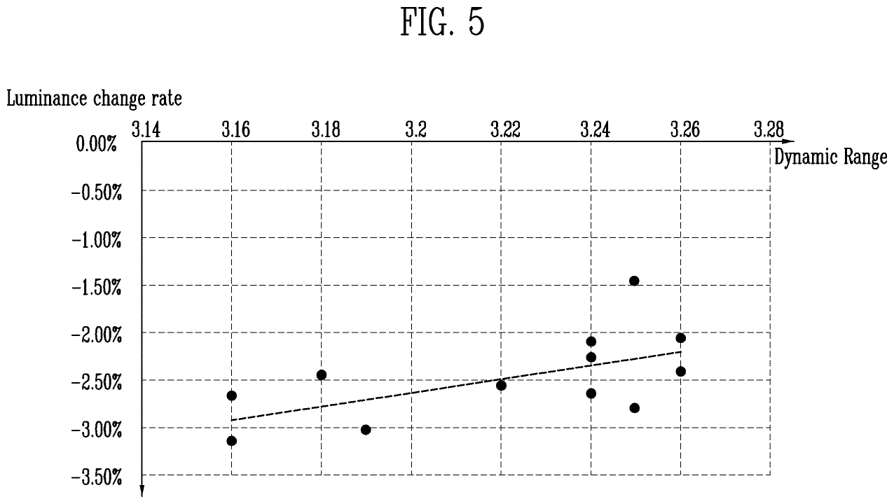

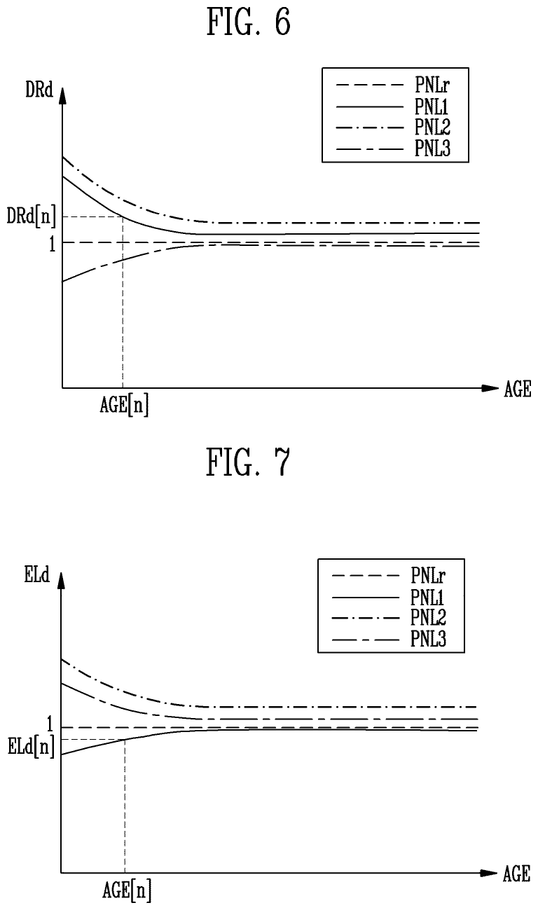

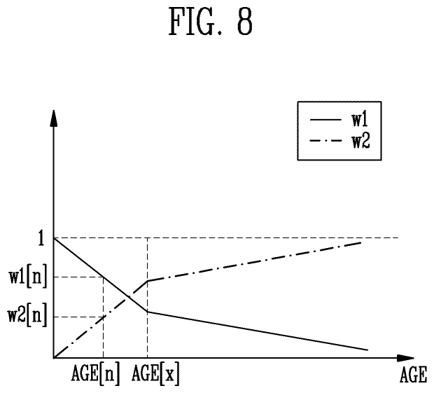

FIG. 4 is a diagram illustrating the degradation compensator 15a in accordance with an embodiment of the present disclosure. FIG. 5 is a diagram illustrating a mutual relationship between a dynamic range and a luminance change rate. FIG. 6 is a diagram illustrating a first gain in accordance with an embodiment of the present disclosure. FIG. 7 is a diagram illustrating a second gain in accordance with an embodiment of the present disclosure. FIG. 8 is a diagram illustrating a first weight and a second weight in accordance with an embodiment of the present disclosure.

Referring to FIG. 4, the degradation compensator 15a in accordance with an embodiment of the present disclosure may include a cumulative degradation value setting component 151a, a compensation value setting component 152, a compensation gain setting component 153, and an output grayscale setting component 154.

Based on a cumulative degradation value AGE[n] of the light emitting element LD and the input grayscale value IGV of the pixel PXij, the degradation compensator 15a may determine (e.g., may set) a compensation value CPV for the input grayscale value IGV. Furthermore, the degradation compensator 15a may determine (e.g., may set) a compensation gain CPG, based on the cumulative degradation value AGE[n] and a dynamic range of the driving transistor T1 of the pixel PXij. In addition, the degradation compensator 15a may determine (e.g., may set) the output grayscale value OGV of the pixel, based on the compensation value CPV and the compensation gain CPG.

First, the cumulative degradation value setting component 151a may calculate a current degradation value based on the temperature information TINF and the input grayscale value IGV, and may update the cumulative degradation value AGE[n−1] by accumulating the current degradation value to the cumulative degradation value AGE[n−1]. For example, the updated cumulative degradation value AGE[n] may be calculated according to Equation 1.

$$AGE [ n ] = AGE [ n - 1 ] + CDA [ n ] \qquad Equation 1$$

In Equation 1, AGE[n−1] may denote a cumulative degradation value AGE[n−1] obtained by accumulating degradation values from a first image frame to an (n−1)th image frame. AGE[n] may denote a cumulative degradation value AGE[n] obtained by accumulating degradation values from the first image frame to an n-th image frame. Here, n is an integer greater than 1. CDA[n] may denote a current degradation value CDA[n] calculated based on the temperature information TINF and the input grayscale value IGV of the n-th image frame. For example, the cumulative degradation value setting component 151a may calculate the current degradation value CDA[n] to be larger as the input grayscale value IGV increases. Furthermore, the cumulative degradation value setting component 151a may calculate the current degradation value CDA[n] to be larger as the estimated temperature based on the temperature information TINF increases. The cumulative degradation value setting component 151a may directly calculate the current degradation value CDA[n] based on the input grayscale value IGV and the temperature information TINF, or may refer to a lookup table (e.g., a pre-stored lookup table).

Based on the cumulative degradation value AGE[n] of the light emitting element LD and the input grayscale value IGV of the pixel PXij, the compensation value setting component 152 may determine (e.g., may set) a compensation value CPV for the input grayscale value IGV. The compensation value CPV may be stored (e.g., may be pre-stored) in the memory 17. In another embodiment, the compensation value CPV may be calculated by the compensation value setting component 152.

The compensation value setting component 152 may determine (e.g., may set) the compensation value CPV for the same input grayscale value IGV to be larger as the cumulative degradation value AGE[n] increases. For example, in the case where the cumulative degradation value AGE[n] is 20 and the input grayscale value is 203, the compensation value CPV may be determined to be (e.g., may be set to) 5. Thereafter, as time passes, in the case where the cumulative degradation value AGE[n] reaches 25 and the input grayscale value is 203, the compensation value CPV may be determined to be (e.g., may be set to) 7.

In the case where the output grayscale value OGV is generated by adding the compensation value CPV to the input grayscale value IGV, a process deviation of the display panel (e.g., the pixel component 14) may not be reflected, thereby resulting in an inaccurate compensation. For example, the driving transistors T1 of the pixels included in the display panel may have different threshold voltages and mobilities from one another. Furthermore, the light emitting elements LD of the pixels included in the display panel may have different emission efficiencies and emission surface areas from one another.

Referring to FIG. 5, a graph showing a luminance change rate as a function of a dynamic range of the driving transistor T1 is illustrated. The dynamic range may refer to a difference between a gate-source voltage of the driving transistor T1 required to flow the driving current corresponding to the minimum grayscale value (e.g., a black grayscale value) and a gate-source voltage of the driving transistor T1 required to flow the driving current corresponding to the maximum grayscale value (e.g., a white grayscale value). The unit of the dynamic range may be volts.

In FIG. 5, an average luminance change rate of the driving transistor T is 0%, and as the dynamic range increases, the luminance change rate increases in a positive direction. Therefore, as the dynamic range of the driving transistor T1 increases, the compensation amount may be reduced, while as the dynamic range of the driving transistor T1 decreases, the compensation amount may be increased.

The compensation gain setting component 153 may determine (e.g., may set) a compensation gain CPG based on the cumulative degradation value AGE[n] and the dynamic range of the driving transistor T1 of the pixel PXij. For example, the compensation gain setting component 153 may determine (e.g., may set) the compensation gain CPG to be smaller as the dynamic range increases.

In an embodiment, the compensation gain setting component 153 may determine (e.g., may set) the compensation gain CPG based on the cumulative degradation value AGE[n], the dynamic range, and at least one of the emission efficiency or the emission surface area of the light emitting element LD.

The emission efficiency may refer to the luminance of the light emitting element LD per unit current. The emission efficiency may vary depending on the material and the shape of the light emitting element LD. As the emission efficiency increases, the same luminance may be achieved using less current. Consequently, the influence of a degradation may be reduced as the emission efficiency increases. Accordingly, the compensation gain setting component 153 may determine (e.g., may set) the compensation gain CPG to be smaller as the emission efficiency increases.

The emission surface area may refer to a surface area of the light emitting element LD on a display surface. As the emission surface area increases, the current density decreases. Thus, the influence of a degradation may be reduced as the emission surface area increases. Accordingly, the compensation gain setting component 153 may determine (e.g., may set) the compensation gain CPG to be smaller as the emission surface area increases.

For example, the compensation gain setting component 153 may determine (e.g., may set) the compensation gain CPG according to Equation 2.

$$CPG = DRd [ n ] * w 1 [ n ] + ELd [ n ] * w 2 [ n ] \qquad Equation 2$$

In Equation 2, CPG may denote a compensation gain CPG. DRd[n] may denote a first gain corresponding to the dynamic range. w1[n] may denote a first weight. ELd[n] may denote a second gain corresponding to at least one of the emission efficiency or the emission surface. w2[n] may denote a second weight.

Referring to FIG. 6, a graph showing the first gain DRd as a function of the cumulative degradation value AGE for a plurality of display panels PNLr, PNL1, PNL2, and PNL3 is illustrated. A reference display panel PNLr may have a first gain DRd of 1, regardless of the cumulative degradation value AGE. For example, with regard to a first display panel PNL1, the first gain DRd may be stored in the memory 17, such that the first gain DRd[n] is loaded when a cumulative degradation value AGE[n] is reached.

For example, the display panels PNL1 and PNL2, each of which has a relatively smaller dynamic range compared to that of the reference display panel PNLr, may have a first gain DRd greater than 1. The display panel PNL3 having a relatively larger dynamic range compared to that of the reference display panel PNLr, may have a first gain DRd less than 1. In an embodiment, as the cumulative degradation value AGE increases, differences between the first gain of the reference display panel PNLr and the first gains DRd of the display panels PNL1, PNL2, and PNL3 may be reduced.

The first gain DRd may be stored (e.g., may be pre-stored) in the memory 17 based on the dynamic range of each of the display panels PNL1, PNL2, and PNL3 measured at a factory stage.

Referring to FIG. 7, a graph showing the second gain ELd as a function of the cumulative degradation value AGE for a plurality of display panels PNLr, PNL1, PNL2, and PNL3 is illustrated. The reference display panel PNLr may have a second gain ELd of 1, regardless of the cumulative degradation value AGE. For example, the first display panel PNL1 may have a second gain ELD[n] at a cumulative degradation value AGE[n].

For example, the display panels PNL2 and PNL3, each of which has a relatively lower emission efficiency compared to that of the reference display panel PNLr, may have a second gain ELd greater than 1. For example, the display panels PNL2 and PNL3, each of which has a relatively smaller emission surface area compared to that of the reference display panel PNLr, may have a second gain ELd greater than 1. The display panel PNL1 that has a relatively higher emission efficiency compared to that of the reference display panel PNLr, may have a second gain ELd less than 1. The display panel PNL1 that has a relatively larger emission surface area compared to that of the reference display panel PNLr, may have a second gain ELd less than 1. In an embodiment, as the cumulative degradation value AGE increases, differences between the second gain of the reference display panel PNLr and the second gains ELd of the display panels PNL1, PNL2, and PNL3 may be reduced.

The second gain ELd may be stored (e.g., may be pre-stored) in the memory 17 based on at least one of the emission efficiency or the emission surface area of each of the display panels PNL1, PNL2, and PNL3 measured at the factory stage. In the case where the second gain ELd is based on both the emission efficiency and the emission surface area, the second gain ELd may be the sum of a 2-1-th gain corresponding to the emission efficiency and a 2-2-th gain corresponding to the emission surface area. The proportion of the 2-1-th gain and the proportion of the 2-2-th may be variously adjusted depending on the cumulative degradation value AGE.

Referring to FIG. 8, a graph showing a first weight w1 and a second weight w2 for the cumulative degradation value AGE is shown.

The compensation gain setting component 153 may determine (e.g., may set) the first weight w1 to be smaller as the cumulative degradation value AGE increases. Furthermore, the compensation gain setting component 153 may determine (e.g., may set) the second weight w2 to be larger as the cumulative degradation value AGE increases. Each of the first weight w1 and the second weight w2 may have a value ranging from 0 to 1. In an embodiment, the sum of the first weight w1 and the second weight w2 may be 1. For example, at the cumulative degradation value AGE[n], the sum of the first weight w1[n] and the second weight w2[n] may be 1. This is because the luminance change rates for the cumulative degradation values AGE of the display panels PNL1, PNL2, and PNL3 may follow the trend of dynamic ranges in an initial stage, and may then follow the trend of emission efficiencies and emission surface areas in a middle or last stage.

The graphs of the first weight w1 and the second weight w2 may each have a slope varying at a cumulative degradation value (e.g., a specific or predetermined cumulative degradation value) AGE[x]. For example, the slope of each of the graphs of the first weight w1 and the second weight w2 may become more gentle when the cumulative degradation value AGE exceeds the cumulative degradation value AGE[x]. Although FIG. 8 illustrates an example in which there is a single cumulative degradation value AGE[x], the present disclosure is not limited thereto, and a plurality of specific cumulative degradation values at which the slope is changed may be used as needed or desired.

The first weight w1 and the second weight w2 may be stored (e.g., may be pre-stored) in the memory 17 in the factory stage. The first weight w1 and the second weight w2 may be determined to be (e.g., may be set to) common values for the display panels PNL1, PNL2, and PNL3. In an embodiment, the first weight w1 and the second weight w2 may be independently determined (e.g., may be independently set) for each of the display panels PNL1, PNL2, and PNL3 depending on process deviations or variations of the display panels PNL1, PNL2, and PNL3.

The output grayscale setting component 154 may determine (e.g., may set) the output grayscale value OGV of the pixel PXij, based on the compensation value CPV and the compensation gain CPG. For example, the output grayscale setting component 154 may determine (e.g., may set) the output grayscale value OGV according to Equation 3.

$$OGV = IGV + CPV * CPG \qquad Equation 3$$

In Equation 3, OGV may denote an output grayscale OGV, IGV may denote an input grayscale IGV, CPV may denote a compensation value CPV, and CPG may denote a compensation gain CPG. In the case of the reference display panel PNLr, the compensation gain CPG may always be 1. In the case of the plurality of display panels PNL1, PNL2, and PNL3, the compensation gain CPG may be greater than 1 or less than 1, depending on at least one of the dynamic range, the emission efficiency, or the emission surface area. Therefore, according to the present embodiment, a degradation may be more accurately compensated for by reflecting the process deviation or variation of each of the display panels PNL1, PNL2, and PNL3.

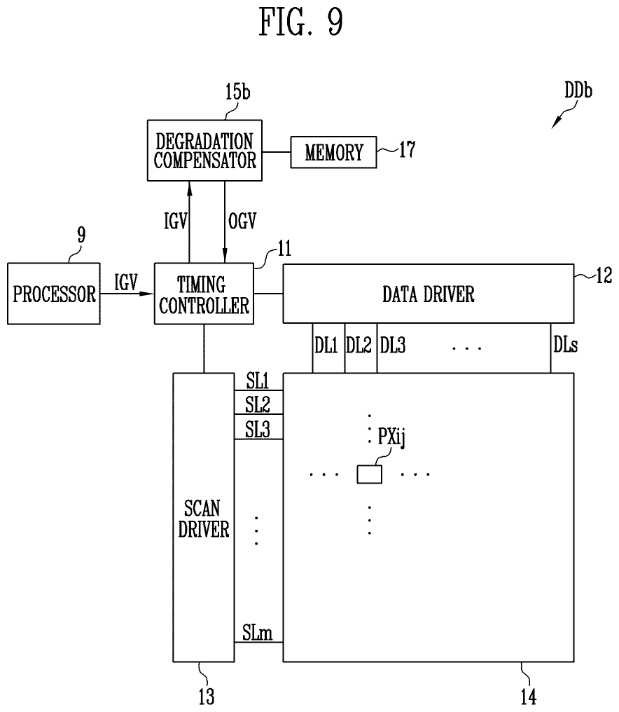

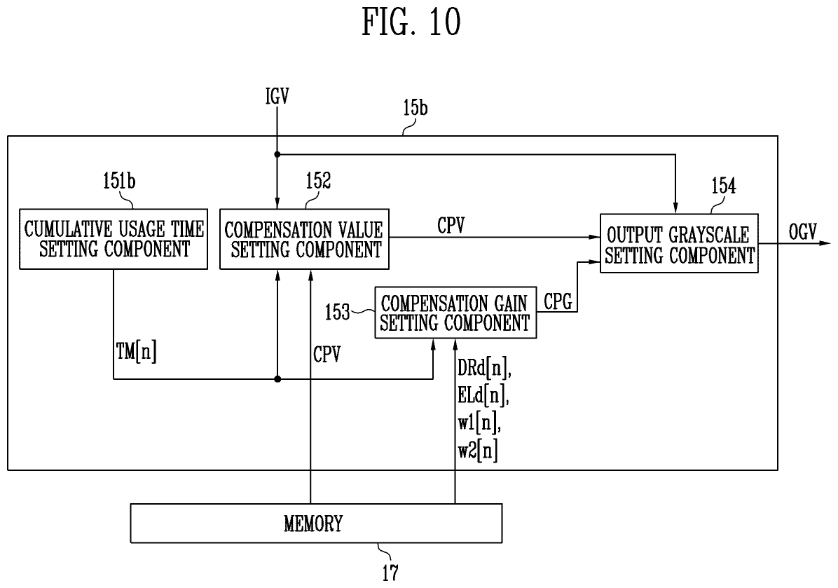

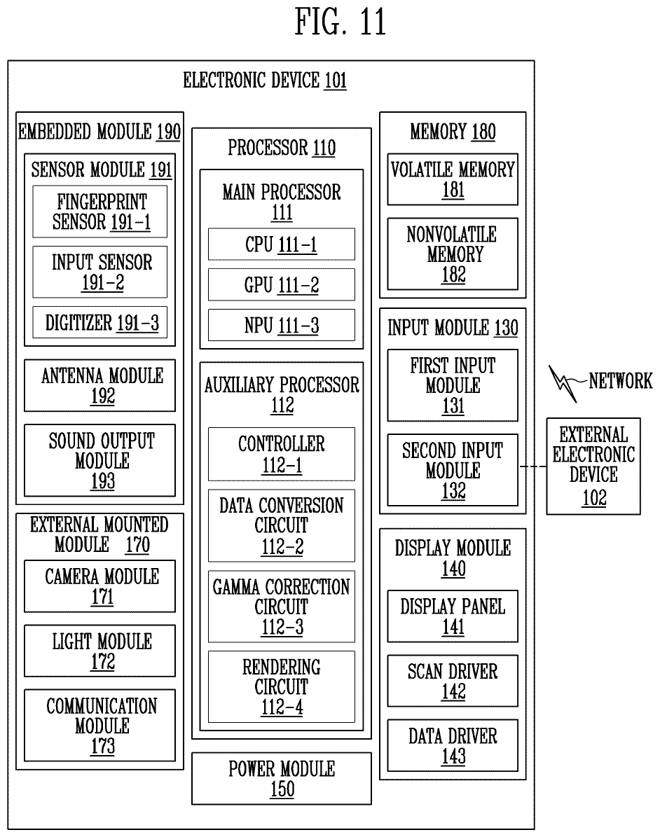

FIG. 9 is a diagram illustrating a display device DDb in accordance with an embodiment of the present disclosure. FIG. 10 is a diagram illustrating a degradation compensator 15b in accordance with an embodiment of the present disclosure.

The display device DDb of FIG. 9 may not include the temperature sensor 16, when compared to the display device DDa described above with reference to FIG. 1.

The degradation compensator 15b of FIG. 10 may include a cumulative usage time setting component 151b instead of the cumulative degradation value setting component 151a of the degradation compensator 15a described above with reference to FIG. 4.

The cumulative usage time setting component 151b may record a cumulative usage time TM[n] during which each pixel PXij has been used. For example, the cumulative usage time setting component 151b may include or use a counter to count time at suitable time intervals (e.g., specific or predetermined time intervals). In this case, the compensation value setting component 152 and the compensation gain setting component 153 may use the cumulative usage time TM[n] instead of the cumulative degradation value AGE[n] to determine (e.g., to set) the compensation value CPV and the compensation gain CPG, respectively.

In the description of the cumulative degradation value AGE[n] above with reference to FIGS. 4 to 8, the cumulative usage time TM[n] may be substituted for the cumulative degradation value AGE[n]. In other words, the embodiments described above with reference to FIGS. 4 to 8 may be applied to the embodiments described with reference to FIGS. 9 and 10.

FIG. 11 is a block diagram of an electronic device 101 in accordance with an embodiment of the present disclosure.

The electronic device 101 may output various suitable kinds of information through a display module 140 in an operating system. If a processor 110 executes an application stored in a memory 180, the display module 140 may provide application information to the user through a display panel 141.

The processor 110 may acquire an external input through an input module 130 or a sensor module 191, and may execute an application corresponding to the external input. For example, in the case where the user selects a camera icon displayed on the display panel 141, the processor 110 may obtain a user input through an input sensor 191-2, and may activate a camera module 171. The processor 110 may transmit image data corresponding to an image captured by the camera module 171 to the display module 140. The display module 140 may display, on the display panel 141, an image corresponding to the captured image.

As another example, in the case where personal information authentication is executed through the display module 140, a fingerprint sensor 191-1 may acquire input fingerprint information as input data. The processor 110 may compare the input data acquired through the fingerprint sensor 191-1 with authentication data stored in the memory 180, and may execute an application depending on a result of the comparison. The display module 140 may display, on the display panel 141, information executed according to a logic of the application.

As another example, in the case where a music streaming icon displayed on the display module 140 is selected, the processor 110 may acquire a user input through the input sensor 191-2, and may activate a music streaming application stored in the memory 180. If a music playing command is input in the music streaming application, the processor 110 may activate a sound output module 193, and may provide sound information corresponding to the music playing command to the user.

A brief description of the operation of the electronic device 101 has been provided. Hereinafter, a configuration of the electronic device 101 will be described in more detail. Some of the components of the electronic device 101 described in more detail below may be integrated into a single component, or one component may be separated into two or more components.

Referring to FIG. 11, the electronic device 101 may communicate with an external electronic device 102 through a network (e.g., a short-range wireless communication network or a long-range wireless communication network). In an embodiment, the electronic device 101 may include a processor 110, a memory 180, an input module 130, a display module 140, a power module 150, an embedded module 190, and an external mounted module 170. In an embodiment, in the electronic device 101, at least one of the foregoing components may be omitted, or one or more other components may be added. In an embodiment, some components (e.g., the sensor module 191, an antenna module 192, or a sound output module 193) among the foregoing components may be integrated into another component (e.g., the display module 140).

The processor 110 may execute software to control at least one other component (e.g., a hardware or software component) of the electronic device 101 connected to the processor 110, and may perform various data processing or computing operations. In an embodiment, as at least a portion of a data processing or computing operation, the processor 110 may store, in a volatile memory 181, a command or data received from another component (e.g., the input module 130, the sensor module 191, or a communication module 173), process the command or data stored in the volatile memory 181, and store result data in a nonvolatile memory 182.

The processor 110 may include a main processor 111 and an auxiliary processor 112. The main processor 111 may include one or more of a central processing unit (CPU) 111-1 and/or an application processor (AP). The main processor 111 may further include any one or more of a graphic processing unit (GPU) 111-2, a communication processor (CP), and/or an image signal processor (ISP). The main processor 111 may further include a neural processing unit (NPU) 111-3. The NPU may be a processor specialized to process an artificial intelligence model. The artificial intelligence model may be generated by machine learning. The artificial intelligence model may include a plurality of artificial neural network layers. An artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more among the foregoing networks, but the present disclosure is not limited thereto. The artificial intelligence model may not only include a hardware structure, but may also include an additional or substitutive software structure. At least two of the foregoing processing units and/or the processors may be implemented as a single integrated component (e.g., a single chip). As another example, the processing units and the processors may be implemented as respective independent components (e.g., a plurality of chips).

The auxiliary processor 112 may include a controller 112-1. The controller 112-1 may include an interface conversion circuit and a timing control circuit. The controller 112-1 may receive an image signal from the main processor 111, may convert a data format of the image signal to a format corresponding to specifications of an interface with the display module 140, and may output image data. The controller 112-1 may output various suitable control signals used to drive the display module 140.

The auxiliary processor 112 may further include a data conversion circuit 112-2, a gamma correction circuit 112-3, a rendering circuit 112-4, and/or the like. The data conversion circuit 112-2 may receive image data from the controller 112-1, compensate for the image data to display an image at a desired luminance based on characteristics of the electronic device 101 or settings of the user, or may convert the image data to reduce a power consumption or to compensate for afterimages. The gamma correction circuit 112-3 may convert image data, a gamma reference voltage, or the like, so that an image to be displayed on the electronic device 101 may have desired gamma characteristics. The rendering circuit 112-4 may receive image data from the controller 112-1, and may render the image data taking into account a pixel arrangement or the like on the display panel 141 applied to the electronic device 101. At least one of the data conversion circuit 112-2, the gamma correction circuit 112-3, or the rendering circuit 112-4 may be integrated into another component (e.g., the main processor 111 or the controller 112-1). At least one of the data conversion circuit 112-2, the gamma correction circuit 112-3, or the rendering circuit 112-4 may be integrated into a data driver 143 described in more detail below.

The memory 180 may store a variety of data to be used in at least one component (e.g., the processor 110 or the sensor module 191) of the electronic device 101, and input data or output data for a command pertaining to the variety of data. The memory 180 may include at least one or more of the volatile memory 181 and/or the nonvolatile memory 182.

The input module 130 may receive a command or data to be used in a component (e.g., the processor 110, the sensor module 191, or the sound output module 193) of the electronic device 101 from an external device (e.g., the user or an external electronic device 102) provided outside the electronic device 101.

The input module 130 may include a first input module 131 to receive a command or data from the user, and a second input module 132 to receive a command or data from the external electronic device 102. The first input module 131 may include a microphone, a mouse, a keyboard, a key (e.g., a button), or a pen (e.g., a passive pen or an active pen). The second input module 132 may support a designated protocol, which may be connected to the external electronic device 102 in a wired or wireless manner. In an embodiment, the second input module 132 may include a high definition multimedia interface (HDMI), a universal serial bus (USB) interface, an SD card interface, or an audio interface. The second input module 132 may include a connector (e.g., an HDMI connector, a USB connector, an SD card connector, or an audio connector (e.g., a headphone connector)) for a physical connection with the external electronic device 102.

The display module 140 may provide visual information to the user. The display module 140 may include a display panel 141, a scan driver 142, and a data driver 143. The display module 140 may further include a window, a chassis, and a bracket to protect the display panel 141.

The display panel 141 may include a liquid crystal display panel, an organic light emitting display panel, or an inorganic light emitting display panel. The kind of display panel 141 is not limited thereto. The display panel 141 may be a rigid kind of panel, or a flexible kind of panel, which is rollable or foldable. The display module 140 may further include a support, a bracket, or a heat dissipater, which supports the display panel 141.

The scan driver 142 may be mounted on the display panel 141 as a driving chip. The scan driver 142 may be integrated on the display panel 141. For example, the scan driver 142 may include an amorphous silicon TFT gate driver circuit, a low temperature polycrystalline silicon (LTPS), a TFT gate driver circuit, or an oxide semiconductor TFT gate driver circuit (OSG), which may be internalized in the display panel 141. The scan driver 142 may receive a control signal from the controller 112-1, and may output scan signals to the display panel 141 in response to the control signal.

The display panel 141 may further include an emission driver. The emission driver may output an emission control signal to the display panel 141 in response to a control signal received from the controller 112-1. The emission driver may be formed separately from the scan driver 142, or may be integrated into the scan driver 142.

The data driver 143 may receive a control signal from the controller 112-1, convert image data to an analog voltage (e.g., a data voltage) in response to the control signal, and output data voltages to the display panel 141.

The data driver 143 may be integrated into another component (e.g., the controller 112-1). The functions of the interface conversion circuit and the timing control circuit of the controller 112-1 may be integrated into the data driver 143.

The display module 140 may further include an emission driver, a voltage generation circuit, and/or the like. The voltage generation circuit may output various suitable voltages used to drive the display panel 141.

The power module 150 may supply power to the components of the electronic device 101. The power module 150 may include a battery to store a power voltage. The battery may include a primary cell, which may not be recharged, and a secondary cell or a fuel cell, which may be rechargeable. The power module 150 may include a power management integrated circuit (PMIC). The PMIC may supply an optimized power to each of the foregoing modules and modules to be described below. The power module 150 may include a wireless power transceiver that is electrically connected with the battery. The wireless power transceiver may include a plurality of coiled antenna radiators.

The electronic device 101 may further include an embedded module 190 and an external mounted module 170. The embedded module 190 may include a sensor module 191, an antenna module 192, and a sound output module 193. The external mounted module 170 may include a camera module 171, a light module 172, and a communication module 173.

The sensor module 191 may sense an input from the body of the user or an input from a pen of the first input module 131, and generate an electric signal or a data value corresponding to the input. The sensor module 191 may include one or more among a fingerprint sensor 191-1, an input sensor 191-2, and/or a digitizer 191-3.

The fingerprint sensor 191-1 may generate a data value corresponding to the fingerprint of the user. The fingerprint sensor 191-1 may include any one of an optical fingerprint sensor and/or a capacitive fingerprint sensor.

The input sensor 191-2 may generate a data value corresponding to coordinate information of the input from the body of the user or the input from the pen. The input sensor 191-2 may generate a data value corresponding to the amount of change in a capacitance by the input. The input sensor 191-2 may sense an input from a passive pen, or transmit or receive data to or from an active pen.

The input sensor 191-2 may measure a biometric signal pertaining to biometric information, such as a blood pressure, body fluid, or body fat. For example, in the case where the user brings a part of his/her body into contact with the sensor layer or the sensing panel and remains stationary for a certain time, the input sensor 191-2 may sense a biometric signal based on a change in an electric field by the part of the user's body, and output information desired by the user to the display module 140.

The digitizer 191-3 may generate a data value corresponding to coordinate information of an input from a pen. The digitizer 191-3 may generate data values corresponding to electromagnetic variations caused by the input. The digitizer 191-3 may sense an input from a passive pen, or transmit or receive data to or from an active pen.

At least one of the fingerprint sensor 191-1, the input sensor 191-2, or the digitizer 191-3 may be implemented as a sensor layer formed on the display panel 141 through a successive process. The fingerprint sensor 191-1, the input sensor 191-2, and the digitizer 191-3 may be disposed over the display panel 141. Any one of the fingerprint sensor 191-1, the input sensor 191-2, or the digitizer 191-3, for example, such as the digitizer 191-3, may be disposed under the display panel 141.

At least two or more of the fingerprint sensor 191-1, the input sensor 191-2, and/or the digitizer 191-3 may be formed to be integrated into a single sensing panel through the same process. In the case where at least two or more among the fingerprint sensor 161-1, the input sensor 161-2, and/or the digitizer 161-3 are integrated into a single sensing panel, the sensing panel may be disposed between the display panel 141 and a window disposed over the display panel 141. In an embodiment, the sensing panel may be disposed on the window, and the position of the sensing panel is not particularly limited.

At least one of the fingerprint sensor 191-1, the input sensor 191-2, or the digitizer 191-3 may be embedded in the display panel 141. In other words, during a process of forming components (e.g., a light emitting element, a transistor, and the like) included in the display panel 141, at least one among the fingerprint sensor 191-1, the input sensor 191-2, and/or the digitizer 191-3 may be formed concurrently or substantially simultaneously with the components.

In addition, the sensor module 191 may generate an electrical signal or data value corresponding to internal conditions or external conditions of the electronic device 101. The sensor module 191 may further include, for example, a gesture sensor, a gyroscope sensor, an atmospheric sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 192 may include one or more antennas to transmit or receive a signal or power to or from an external device. In an embodiment, the communication module 173 may transmit a signal to an external electronic device or receive a signal from the external electronic device through an antenna suitable for a communication scheme. An antenna pattern of the antenna module 192 may be integrated to a component of the display module 140 (e.g., the display panel 141 of the display module 1140) or the input sensor 191-2.

The sound output module 193 may be a device for outputting a sound signal to a device provided outside the electronic device 101, and for example, may include a speaker used for typical purposes such as reproducing multimedia or record data, and a receiver used only for phone reception. In an embodiment, the receiver may be integrally or separately formed with a speaker. A sound output pattern of the sound output module 193 may be integrated into the display module 140.

The camera module 171 may capture a static image or a video. In an embodiment, the camera module 171 may include one or more lenses, an image sensor, or an image signal processor. The camera module 171 may further include an infrared camera capable of sensing the presence of the user, the position of the user, a line of sight of the user, and/or the like.

The light module 172 may provide light. The light module 172 may include a light emitting diode or a xenon lamp. The light module 172 may be operated interlocking with the camera module 171 or operated independently therefrom.

The communication module 173 may form a wired or wireless communication channel between the electronic device 101 and the external electronic device 102, and support execution of communication through the formed communication channel. The communication module 173 may include either or both a wireless communication module such as a cellular communication module, a short-range wireless communication module, or a global navigation satellite system (GNSS) communication module, and a wired communication module such as a local area network (LAN) communication module, or a power line communication module. The communication module 173 may communicate with the external electronic device 102 through a short-range communication network such as Bluetooth, WiFi Direct or infrared data association (IrDA), or a long-range communication network such as a cellular network, an internet, or a computer network (e.g., LAN or WAN). The various kinds of communication modules 173 described above may be implemented as a single chip or may be implemented as respective separate chips.

The input module 130, the sensor module 191, the camera module 171, and the like interlocking with the processor 110 may be used to control the operation of the display module 140.

The processor 110 may output a command or data to the display module 140, the sound output module 193, the camera module 171, or the light module 172, based on input data received from the input module 130. For example, the processor 110 may generate image data in response to input data applied through a mouse, an active pen, or the like, and output the image data to the display module 140, or may generate command data in response to input data, and output the command data to the camera module 171 or the light module 172. In the case where input data is not received from the input module 130 for a certain time, the processor 110 may convert the operation mode of the electronic device 101 into a low-power mode or a sleep mode, so that a power consumption of the electronic device 101 may be reduced.

The processor 110 may output a command or data to the display module 140, the sound output module 193, the camera module 171, or the light module 172, based on sensing data received from the sensor module 191. For example, the processor 110 may compare authentication data applied from the fingerprint sensor 191-1 with the authentication data stored in the memory 180, and may execute an application depending on a result of the comparison. The processor 110 may execute a command based on sensing data sensed by the input sensor 191-2 or the digitizer 191-3, or output corresponding image data to the display module 140. In the case where the sensor module 191 includes a temperature sensor, the processor 110 may receive temperature data for a measured temperature from the sensor module 191, and may further execute a luminance correction operation for the image data based on the temperature data.

The processor 110 may receive measurement data for the presence of the user, the position of the user, a line of sight of the user, or the like from the camera module 171. The processor 110 may further execute a luminance correction operation for the image data based on the measurement data. For example, the processor 110 that has determined that the user is present through an input from the camera module 171 may output, to the display module 140, image data having a luminance that is corrected by the data conversion circuit 112-2 or the gamma correction circuit 112-3.

Some components among the foregoing components may be connected to each other by a communication scheme, e.g., a bus, general purpose input/output (GPIO), a serial peripheral interface (SPI), a mobile industry processor interface (MIPI), or a ultra path interconnect (UPI) link, which can be used between peripheral devices, and may thus exchange a signal (e.g., a command or data) therebetween. The processor 110 may communicate with the display module 140 through a predefined interface. For example, any one of the foregoing communication schemes may be used, and the interface is not limited to the foregoing communication schemes.

The electronic device 101 in accordance with various embodiments of the present disclosure may be used to implement various suitable kinds of devices. The electronic device 101 may include, for example, at least one of a portable telecommunication device (e.g., a smart phone), a computer, a portable multimedia device, a portable medical device, a camera, wearable device, or a home appliance. However, the present disclosure is not limited to the foregoing devices.

Various embodiments of the present disclosure may provide a display device and a method of driving the display device, capable of more accurately compensating for a degradation by reflecting a process deviation or variation of each display panel.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a pixel comprising a light emitting element; and
a degradation compensator configured to determine a compensation value for an input grayscale value of the pixel, based on the input grayscale value and at least one of a cumulative usage time or a cumulative degradation value of the light emitting element,
wherein the degradation compensator is configured to determine a compensation gain, based on a dynamic range of a driving transistor of the pixel and at least one of the cumulative usage time or the cumulative degradation value, and
wherein the degradation compensator is configured to determine an output grayscale value of the pixel, based on the compensation value and the compensation gain.

2. The display device according to claim 1, wherein the dynamic range corresponds to a difference between a gate-source voltage of the driving transistor to flow a driving current corresponding to a minimum grayscale value and a gate-source voltage of the driving transistor to flow a driving current corresponding to a maximum grayscale value.

3. The display device according to claim 1, wherein the degradation compensator is configured to determine the compensation gain based on at least one of the cumulative usage time or the cumulative degradation value, the dynamic range, and at least one of an emission efficiency or an emission surface area of the light emitting element.

4. The display device according to claim 3, wherein the degradation compensator is configured to determine the compensation gain to be smaller as the dynamic range increases.

5. The display device according to claim 4, wherein the degradation compensator is configured to determine the compensation gain to be smaller as the emission efficiency increases.

6. The display device according to claim 5, wherein the degradation compensator is configured to determine the compensation gain to be smaller as the emission surface area increases.

7. The display device according to claim 6, wherein the degradation compensator is configured to determine a first weight applied to the dynamic range to be a smaller value as the cumulative usage time and the cumulative degradation value increase.

8. The display device according to claim 7, wherein the degradation compensator is configured to determine a second weight applied to at least one of the emission efficiency or the emission surface area to be a larger value as the cumulative usage time and the cumulative degradation value increase.

9. The display device according to claim 8, wherein the degradation compensator is configured to determine the compensation gain according to CPG=DRd[n]*w1[n]+ELd[n]*w2[n], where CPG denotes the compensation gain, DRd[n] denotes a first gain corresponding to the dynamic range, w1[n] denotes the first weight, ELd[n] denotes a second gain corresponding to the emission efficiency and the emission surface area, and w2[n] denotes the second weight.

10. The display device according to claim 9, wherein the degradation compensator is configured to determine the output grayscale value according to OGV=IGV+CPV*CPG, where OGV denotes the output grayscale value, IGV denotes the input grayscale value, CPV denotes the compensation value, and CPG denotes the compensation gain.

11. A method of driving a display device, comprising:
receiving an input grayscale value of a pixel comprising a light emitting element;
determining a compensation value for the input grayscale value, based on the input grayscale value and at least one of a cumulative usage time or a cumulative degradation value of the light emitting element;
determining a compensation gain, based on a dynamic range of a driving transistor of the pixel and at least one of the cumulative usage time or the cumulative degradation value; and
determining an output grayscale value of the pixel based on the compensation value and the compensation gain.

12. The method according to claim 11, wherein the dynamic range corresponds to a difference between a gate-source voltage of the driving transistor to flow a driving current corresponding to a minimum grayscale value and a gate-source voltage of the driving transistor to flow a driving current corresponding to a maximum grayscale value.

13. The method according to claim 11, wherein the determining of the compensation gain comprises determining the compensation gain, based on at least one of the cumulative usage time or the cumulative degradation value, the dynamic range, and at least one of an emission efficiency or an emission surface area of the light emitting element.

14. The method according to claim 13, wherein the determining of the compensation gain comprises determining the compensation gain to be smaller i) as the dynamic range increases, ii) as the emission efficiency increases, or iii) as the emission surface area increases.

15. The method according to claim 14, wherein the determining of the compensation gain comprises determining a first weight applied to the dynamic range to be a smaller value as the cumulative usage time and the cumulative degradation value increase.

16. The method according to claim 15, wherein the determining of the compensation gain comprises determining a second weight applied to at least one of the emission efficiency or the emission surface area to be a larger value as the cumulative usage time and the cumulative degradation value increase.

17. The method according to claim 16, wherein the compensation gain is determined according to CPG=DRd[n]*w1[n]+ELd[n]*w2[n], where CPG denotes the compensation gain, DRd[n] denotes a first gain corresponding to the dynamic range, w1[n] denotes the first weight, ELd[n] denotes a second gain corresponding to the emission efficiency and the emission surface area, and w2[n] denotes the second weight.

18. The method according to claim 17, wherein the output grayscale value is determined according to OGV=IGV+CPV*CPG, where OGV denotes the output grayscale value, IGV denotes the input grayscale value, CPV denotes the compensation value, and CPG denotes the compensation gain.

19. An electronic device comprising:
a processor configured to provide an image signal; and
a display device configured to display an image based on the image signal, the display device comprising:
a pixel comprising a light emitting element; and
a degradation compensator configured to determine a compensation value for an input grayscale value of the pixel, based on the input grayscale value and at least one of a cumulative usage time or a cumulative degradation value of the light emitting element,
wherein the degradation compensator is configured to determine a compensation gain, based on a dynamic range of a driving transistor of the pixel and at least one of the cumulative usage time or the cumulative degradation value, and
wherein the degradation compensator is configured to determine an output grayscale value of the pixel, based on the compensation value and the compensation gain.

20. The electronic device according to claim 19, wherein the dynamic range corresponds to a difference between a gate-source voltage of the driving transistor to flow a driving current corresponding to a minimum grayscale value and a gate-source voltage of the driving transistor to flow a driving current corresponding to a maximum grayscale value.
